(19) United States
(12) Patent Application Publication
(10) Pub. No.: US 2015/0269499 A1
(43) Pub. Date: Sep. 24, 2015

(54) METHOD AND SYSTEM FOR FACILITATING KNOWLEDGE MANAGEMENT

(71) Applicant: Tata Consultancy Services Limited, Maharashtra (IN)

(72) Inventors: Ohm Kumar B, Chennai (IN); Balamurugan M, Chennai (IN); Suresh Babu P, Chennai (IN)

(21) Appl. No.: 14/456,571

(22) Filed: Aug. 11, 2014

(30) Foreign Application Priority Data
Mar. 19, 2014 (IN) 902/MUM/2014

(51) Int. Cl. G06Q 10/06

(52) U.S. Cl. CPC G06Q 10/063; G06Q 10/06398

(57) ABSTRACT

Disclosed is a method and system for facilitating knowledge management. A plurality of users into a plurality of groups and each user is assigned a role and an access right. A document workflow may be defined for approval of a plurality of documents of distinct data types. The plurality of documents may be approved by one or more users of the plurality of users based upon the role and the access right. The plurality of documents may be stored in a plurality of workspaces based upon the approval. A group of the plurality of groups may be tagged to a workspace of the plurality of the workspaces such that one or more users belonging to the group are authorized to access the workspace and the documents stored therein based upon the role and the access right.

### CROSS-REFERENCE TO RELATED APPLICATIONS AND PRIORITY

The present application claims priority to Indian Patent Application No. 902/MUM/2014, filed on Mar. 19, 2014, the entirety of which is hereby incorporated by reference.

### TECHNICAL FIELD

The present disclosure described herein, in general, relates to methods and systems facilitating knowledge management, and more particularly to systems and methods facilitating knowledge management in an organization.

### BACKGROUND

Knowledge management plays a significant role in enhancing knowledge of various stakeholders belonging to an organization. The Knowledge management is a systematic process of capturing, designing, sharing, and effectively using the knowledge in order to achieve objectives/goals of the organization by making the best use of knowledge. In the present state of art, since there is no effective and efficient centralized system and/or repository capable of capturing, designing and sharing the knowledge, there exist numerous challenges when it comes to effective management of the knowledge.

One of the challenges is availability of multiple versions of documents which may be scattered across different locations/folders. The stakeholders interested in accessing these multiple versions may have to spend more time searching and tracking the required document. Further, there is a challenge to track and/or monitor frequent modification in the versions of the documents in order to ensure that the stakeholder is accessing and/or reviewing the most recently updated version of the document.

Another challenge is to maintain data security and control access rights in a manner such that only a few set of people in the organization are provided with more privilege rights pertaining to review/modification/approval of the documents. Further, there is a challenge with respect to the language of the documents. For instance, some of the stakeholders may not be able to comprehend default language associated with the documents and hence may not be able to acquire the knowledge disseminated through these documents. This scenario typically arises due to the presence of the organizational units at multiple geographical locations having different languages.

### SUMMARY

This summary is provided to introduce aspects related to systems and methods for facilitating knowledge management and the aspects are further described below in the detailed description. This summary is not intended to identify essential features of the claimed disclosure nor is it intended for use in determining or limiting the scope of the claimed disclosure.

In one implementation, a method for facilitating knowledge management is disclosed. The method includes providing a computing system connectable to a plurality of user devices, the computing system comprising a processor, an input/output interface, and a memory. The memory has stored therein a workflow module and a workspace module. The workflow module is configurable by an authorized user to define categories for dividing users into a plurality of groups and to define a role and access rights for the users in each of the plurality of groups. The workspace module is configurable by the authorized user to store documents in separate workspaces based on the roles and access rights defined for the users in the workflow module. The method includes categorizing, based on the workflow module configured by the authorized user, a plurality of users into a plurality of groups, wherein each user is assigned a role and an access right by the workflow module. The method then includes defining within the workflow module, as configured by the authorized user, a document workflow hierarchy for approval of a plurality of documents of distinct data types. The approval is based upon the role and the access right assigned to one or more users. Further, the method includes storing within one of the separate workspaces a document of a distinct data type based upon the approval granted by one or more of the plurality of users as set by the workflow module. Also, the method includes tagging by the workspace module a group of users from the plurality of groups to one of the separate workspaces such that one or more users belonging to the group are authorized to access the based upon the role and the access rights thereof.

In another implementation, a system for facilitating knowledge management is disclosed. The system may comprise a processor and a memory coupled to the processor for executing a plurality of modules stored in the memory. The plurality of modules may comprise a workflow module, and a workspace module. The workflow module may be configured to categorize a plurality of users into a plurality of groups, wherein each user is assigned a role and an access right. Further, the workflow module may be configured to define a document workflow for approval of a plurality of documents of distinct data types. The plurality of documents may be approved by one or more users of the plurality of users based upon the role and the access right assigned to one or more users. The workspace module may be configured to store the plurality of documents in a plurality of workspaces based upon the approval of the plurality of documents. The workspace module may be further configured to tag a group of the plurality of groups to a workspace of the plurality of the workspaces such that one or more users belonging to the group are authorized to access the workspace and the documents stored therein. The one or more users are authorized to access the workspace based upon the role and the access right.

In yet another implementation, a computer program product having embodied thereon a computer program for facilitating knowledge management is disclosed. The computer program product may comprise an instruction for categorizing a plurality of users into a plurality of groups, wherein each user is assigned a role and an access right. The computer program product may comprise an instruction for defining a document workflow for approval of a plurality of documents of distinct data types. The plurality of documents may be approved by one or more users of the plurality of users based upon the role and the access right assigned to one or more users. Further, the computer program product may comprise an instruction for storing the plurality of documents in a plurality of workspaces based upon the approval of the plurality of documents. The computer program product may comprise an instruction for tagging a group of the plurality of groups to a workspace of the plurality of the workspaces such that one or more users belonging to the group are authorized to access the workspace and the documents stored therein. The one or more users are authorized to the workspace based upon the role and the access right.

### BRIEF DESCRIPTION OF THE DRAWINGS

The detailed description is described with reference to the accompanying figures. The same numbers are used throughout the drawings to refer to like features and components.

FIG. 1 illustrates a network implementation of a system for facilitating knowledge management.

FIG. 2 illustrates an embodiment of the system portion of FIG. 1.

FIG. 3 illustrates various modules and/or components of the system portion of FIG. 1.

FIG. 4A illustrates an example of a tree view structure for an arrangement of documents for use within the system of FIG. 1.

FIG. 4B illustrates an example of searching using tagged keywords to search documents stored within a workspace.

FIG. 5 illustrates a document workflow corresponding to a knowledge document workspace.

FIG. 6 illustrates a SOP workflow corresponding to a SOP document workspace.

FIG. 7 illustrates an assessment workflow corresponding to an assessment document workspace.

FIG. 8 illustrates a method for facilitating knowledge management.

### DETAILED DESCRIPTION

Systems and methods for facilitating knowledge management are described. The systems and methods enable an effective and efficient knowledge management process of capturing, developing, sharing, and effectively using an organizational knowledge. In order to facilitate the knowledge management, initially, a plurality of users may be categorized into a plurality of groups. The plurality of users may be at least one of knowledge providers or knowledge seekers. Each user may be assigned a role and an access right. In one example, the role assigned may be at least one of a super admin, an admin, an author, a reviewer, and a team member. Further, corresponding to each role, the access right is assigned.

Based upon the role and the access right assigned to one or more users of the plurality of users, a document workflow may be defined for approval of a plurality of distinct data types. In one embodiment, the document workflow may be updated by modifying the role and the access right, or adding a new role and a new access right, or deleting the role and the access right. The plurality of documents of distinct data types are approved by the one or more users as per the document workflow defined. The plurality of documents may comprise at least one of a knowledge document, a standard operating procedure (SOP) document, an assessment document, a frequently asked question (FAQ) document, and the like. The knowledge document may be associated with training material, and wherein the assessment document is associated with evaluation of the one or more users based upon the training material. In one embodiment, the plurality of documents may be created using a plurality of predefined templates. The plurality of predefined templates comprises a plurality of predefined fields that include at least one of a text box, a drop down, a date, a hyperlink, and an attachment.

Subsequent to the approval, the plurality of documents may be stored in a plurality of workspaces. The plurality of documents stored in the plurality of workspaces may comprise at least one of the knowledge document, the standard operating procedure (SOP) document, the assessment document, the frequently asked question (FAQ) document, and the like. The plurality of documents may be arranged in a folder structure. The folder structure may comprise a document, along with one or more supporting documents associated to the said document. Further, the plurality of documents may be arranged in a tree view structure. The tree view structure may comprise a parent document, along with one or more child documents of the parent document. During the storage of the plurality of documents in the plurality of workspaces, contents associated with the plurality of documents may be saved in internal databases of the plurality of workspaces.

After the storage of the plurality of documents in the plurality of workspaces, a group of the plurality of groups may be tagged to a workspace of the plurality of the workspaces such that one or more users belonging to the group are authorized to access the workspace and the documents stored therein. Specifically, the one or more users may be authorized to access the workspace based upon the role and the access right. The methods and systems further enables monitoring revisions made, by one or more users, in at least document belonging to at least one workspace. The revisions may be indicated as minor variations when percentage of the revisions is less than or equal to a predefined percentage value. Further, the revisions may be indicated as major variations when the percentage of the revisions is greater than the predefined percentage value. At least one document may be replaced with at least one new document based upon the revisions made in at least one document. In one embodiment, the replacement of at least one document with at least one new document results in updating version nomenclature of at least one new document. The updating of the version nomenclature is based upon the revisions being indicated as one of the minor variations and the major variations. Specifically, the version nomenclature updated in case of the minor variations is distinct as compared to the version nomenclature updated in case of the major variations.

In one example, version number of at least one new document may be updated based upon percentage of changes/revisions made in at least one new document as compared to the at least one document. If the percentage of changes/revisions is less than or equal to a predefined percentage value, then the changes/revisions may be considered to be minor variations, whereas if the percentage of changes/revisions is greater than the predefined percentage value, then the changes/revisions may be considered to be major variations. In any case, the at least one new document may be replaced with the at least one document. However, depending on the variations of the contents, the version number updated may vary. More particularly, the version number updated for the minor variations may be distinct as compared to the version number updated for the minor variations. For example, if a document ‘X’ having version 1.0 is replaced with a new document having the same name ‘X’, then if the changes in contents of the new document is greater than a predefined percentage value, say 33%, then the new document ‘X’ may be updated with a version number 2.0. Alternatively, if the changes in contents of the new document are less than or equal to the predefined percentage value i.e. 33%, then the new document ‘X’ may be updated with a version number 1.1.

After the replacement of the at least one document, the one or more users may be notified. Similarly, the one or more users may be notified when the document workflow is modified or the plurality of documents is stored in the plurality of workspaces. The one or more users of the plurality of users may be enabled to search the plurality of documents using one or more search criteria comprising at least one of a keyword, a document name, a document type, a version number, a phrase, a synonym, a field, a tree view, and a tagged keyword. In one embodiment, the search may be further performed on the contents saved in the internal databases of the plurality of workspaces. The search performed may enable identification of content relevant to one of the keyword, the synonym, and the phrase. Further, the content may enable in retrieval of at least one document associated with the content identified as relevant. In one embodiment, contents of the plurality of documents may be displayed in a language associated with a geographical location of the plurality of users. In one implementation, the geographical location is determined based upon Global Positioning System (GPS) information associated with one or more display devices of the plurality of users. A plurality of activities associated to the plurality of users may be captured using an image capturing means in order to generate an image/video file storing the plurality of activities. In one embodiment, a portion or a section of a document may be automatically updated based on an email or a Short Message Service (SMS) received from a user. The email or the SMS may comprise content to be updated corresponding to the portion or the section of the document. Further, the email or the SMS may comprise the name of the document and the portion or the section of the document to be updated.

While aspects of the described system and the method for facilitating knowledge management may be implemented in any number of different computing systems, environments, and/or configurations, the embodiments are described in the context of the following exemplary system.

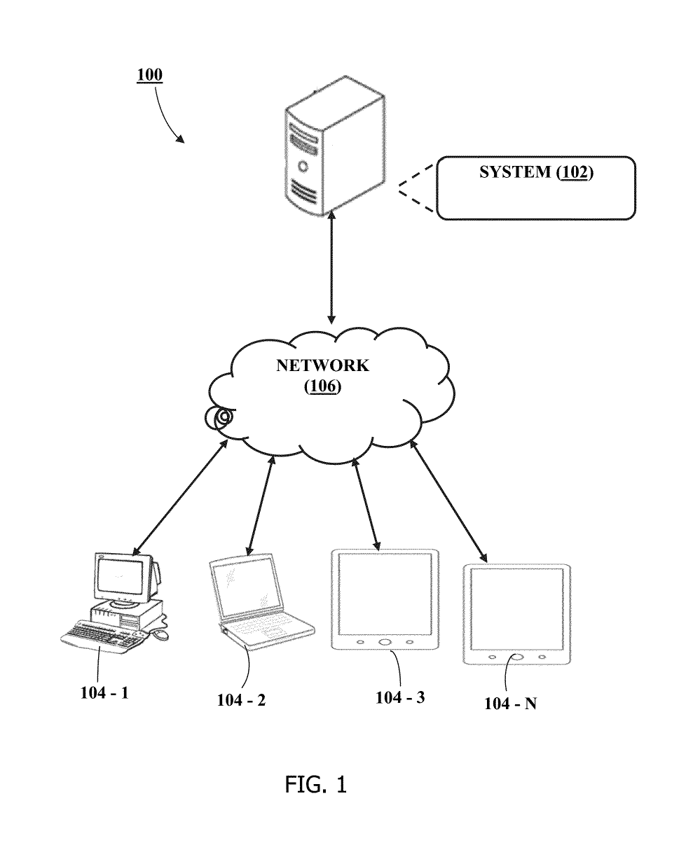

Referring now to FIG. 1, a network implementation 100 of a system 102 for facilitating knowledge management is illustrated, in accordance with an embodiment of the present disclosure. In one embodiment, the system 102 may be configured to categorize a plurality of users into a plurality of groups, wherein each user is assigned a role and an access right. Further, the system 102 may be configured to define a document workflow for approval of a plurality of documents of distinct data types. The plurality of documents may be approved by one or more users of the plurality of users based upon the role and the access right assigned to the one or more users. The system 102 may be configured to store the plurality of documents in a plurality of workspaces based upon the approval of the plurality of documents. The system 102 may be further configured to tag a group of the plurality of groups to a workspace of the plurality of the workspaces such that one or more users belonging to the group are authorized to access the workspace and the documents stored therein. The one or more users are authorized to access the workspace based upon the role and the access right.

Although the present disclosure is explained considering that the system 102 is implemented as a server, it may be understood that the system 102 may also be implemented in a variety of computing systems, such as a laptop computer, a desktop computer, a notebook, a workstation, a mainframe computer, a network server, and the like. In one implementation, the system 102 may be implemented in a cloud-based environment. It will be understood that the system 102 may be accessed by multiple users through one or more user devices 104-1, 104-2, 104-3 . . . 104-N, collectively, also referred to as a user device 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

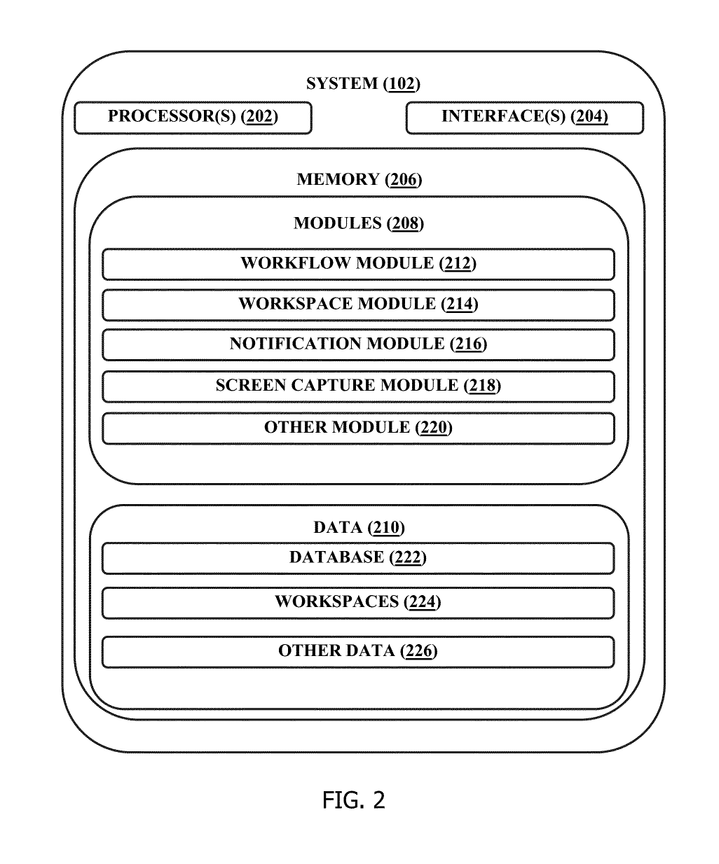

Referring now to FIG. 2, the system 102 is illustrated in accordance with an embodiment of the present disclosure. In one embodiment, the system 102 may include at least one processor 202, an input/output (I/O) interface 204, and a memory 206. At least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user device 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a workflow module 212, a workspace module 214, a notification module 216, a screen capture module 218, and other module 220. The other module 220 may include programs or coded instructions that supplement applications and functions of the system 102.

The data 210, among other things, serves as a repository for storing data processed, received, and generated by one or more of the modules 208. The data 210 may also include a database 222, workspaces 224, and other data 226. The other data 226 may include data generated as a result of the execution of one or more modules in the other module 220.

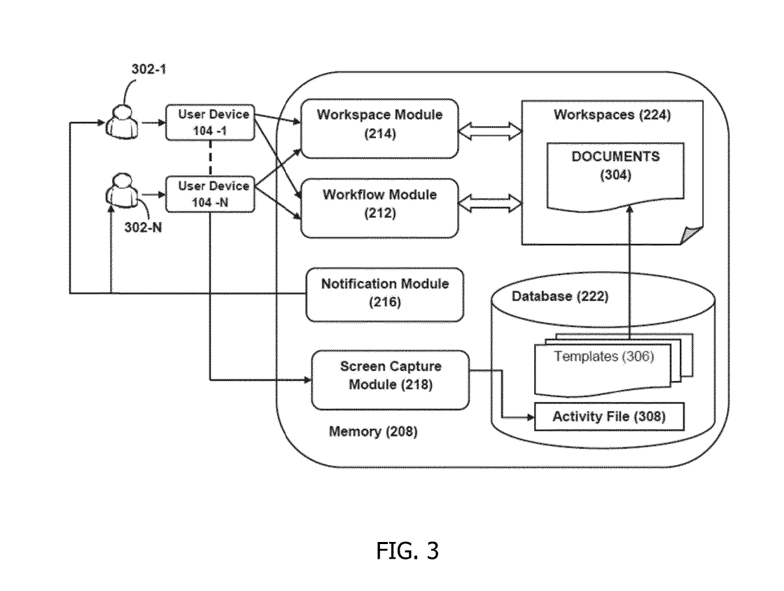

In one implementation, at first, a user may use the user device 104 to access the system 102 via the I/O interface 204. The user may register themselves using the I/O interface 204 in order to use the system 102. The working of the system 102 using the plurality of modules 208 is explained in detail referring to FIGS. 3-7 as explained below.

### Workflow Module 212

In an embodiment, the workings of the workflow module 212 along with other components of the system 102 is explained referring to FIG. 3. As shown in FIG. 3, a plurality of users 302-1 . . . 302-N, hereinafter referred to as users 302, may access the system 102 using a plurality of user devices 104-1 . . . 104-N, hereinafter referred to as user devices 104. The workflow module 212 may be initially configured to categorize the users 302 into a plurality of groups. In one example, assume the organization comprises various departments including Human Resource Department (HRD), Research & Development Department (R&D), Accounts Department (A/C), Administration Department, and the like. Therefore, based upon the department, such as user 302-1, the user may be categorized into at least one group such as HRD Group, R&D Group, A/C Group, Administration Group, and the like. Similarly, based upon other departments corresponding to other users, the other users may be categorized into different groups by the workflow module 212. The workflow module 212 may be further configured to assign a role and an access right to each user of the plurality of groups. The role assigned may be at least one of a super admin, an admin, an author, a reviewer, and a team member. Further, the access right may be assigned to each user based upon the role of each user.

Subsequent to the categorization of the users 302 in the plurality of groups, the workflow module 212 may be configured to define a document workflow for approval of a plurality of documents, hereinafter referred to as documents 304 as shown in FIG. 3. The documents 304 may be of distinct data types. The plurality of documents may comprise knowledge documents or training materials, standard operating procedures (SOPs) documents, Frequently Asked Question (FAQ) documents, assessment documents, and the like. In one example, if the organization is an Information Technology (IT) based company, the documents 304 may include training materials on technologies such as JAVA programming language, J2EE, SQL, JSP, Servletes, Mainframe, and the like. The standard operating procedures (SOP) may include strategies/methodologies to be adopted in order to execute projects related to the aforementioned technologies. The FAQs may include frequently asked questions related to the aforementioned technologies. Further, the assessments may include assessment/test of the user 302 based upon the knowledge/skills obtained by referring to the training materials, the standard operating procedures (SOPs), and the Frequently Asked Questions (FAQs). In one embodiment, the documents 304 may be created using templates 306 stored in the database 222. The templates 306 may comprise predefined fields including at least one of a text box, a drop down, a date, a hyperlink, an attachment, and the like.

The documents 304 may be approved by one or more users of the users 302 based upon the role and the access right assigned to the one or more users. Specifically, the approval of the documents 304 may be defined in the document workflow such that the documents 304 are first approved by a first user, then by a second user, and then by a third user, and the like. For example, considering the above scenario of the IT based company, if there is a document relevant to training material for JAVA programming language, and the document is drafted by a team member, then as per the document workflow defined by the workflow module 212, the training material for JAVA programming language may be routed to a team leader, then to a manager, and finally to a senior manager for the approval. Such definition of the document workflow in order to approve the documents 304 may be configurable and hence may be modified/updated based upon the requirements of the organization. More particularly, the document workflow may be modified, any time, via the workflow module 212 by performing at least one of modifying the role and the access right, adding a new role and a new access right, and deleting the role and the access right.

### Workspace Module 214

Once the document workflow is defined by the workflow module 212, the workspace module 214 may be configured to store the documents 304 in the workspaces 224. The documents 304 may be stored in the workspaces 224 based upon the approval of the documents 304 by the one or more users. In one example, considering the above scenario of the IT-based company, there are three documents created, out of which a first document is training material related to JAVA programming language, a second document related to SOPs to be followed, and a third document related to assessment on JAVA programming language, then the training material related to JAVA programming language will be stored in a first workspace (viz. a document workspace), the SOP will be stored in a second workspace (viz. a SOP workspace), and the assessment on JAVA programming language will be stored in the first workspace (viz. document workspace). Therefore, it must be understood that a dedicated workspace (such as the document workspace) may be configured to store one or more documents related to the training material, assessment and FAQs, etc., while another distinct workspace (SOP workspace) may be configured to store one or more documents related to the standard operating procedures (SOP).

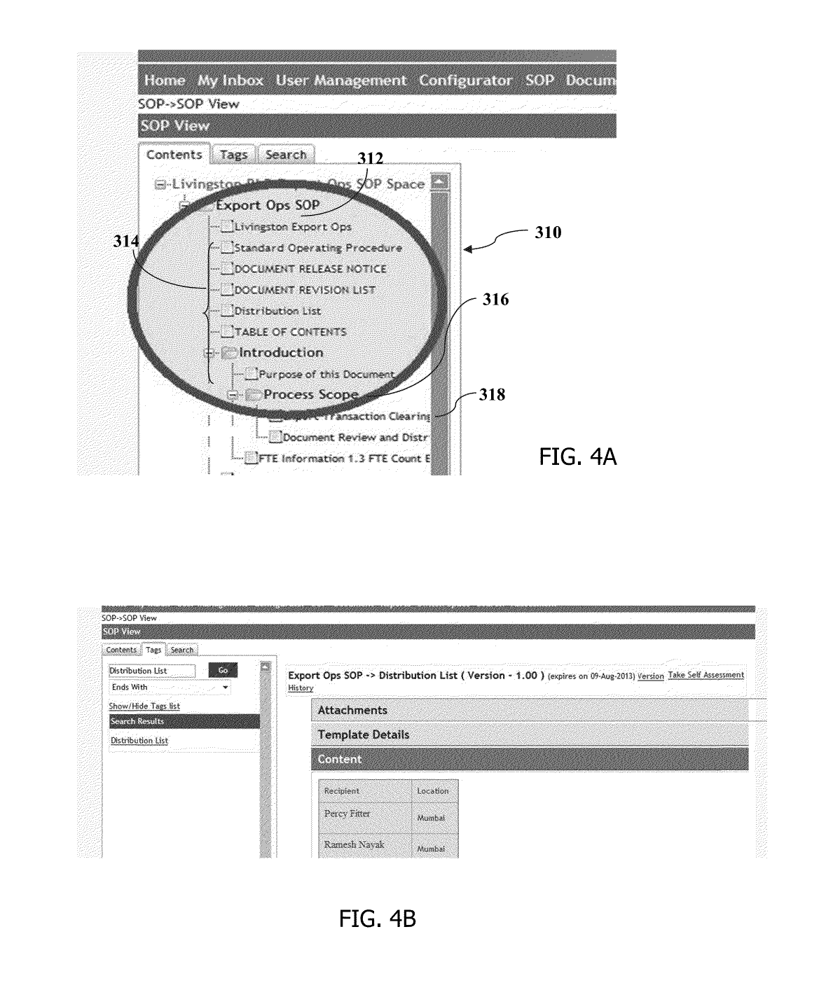

In one embodiment, the workspace module 214 may be further configured to arrange each document stored in each workspace in a folder structure. The folder structure may comprise a knowledge document and one or more supporting documents associated to the said knowledge document. In one example, if the knowledge document is training material related to JAVA programming language, the folder structure may comprise the training material related to JAVA programming language and supporting documents related to the JAVA programming language such as JSP, Servlet, Struts, and JDBC, and the like. The folder structure creates a hierarchy of documents with a main folder comprising a sub-folder, the sub-folder further comprising another sub-folder, and so on. In one embodiment, the workspace module 214 may be further configured to arrange each document in a tree view structure. The tree view structure comprises a parent document and one or more child documents of the parent document. The tree view structure enables the users 302 to navigate intuitively to the parent document, contents of the parent document, a section in the parent document, and the one or more child documents of the parent document. FIG. 4A illustrates an example of the tree view structure 310 wherein a parent SOP titled “Export Ops SOP” 312 is shown comprising one or more sections 314 associated with the parent SOP 312. Further, there is a child document titled “Introduction” 316 comprising a sub-section/sub-content 318.

During the storage of the documents 304, the workspace module may be configured to store metadata associated with each document such as document type/category, version number, name, creation date, expiry date, and the like. In one embodiment, the users 302 may not be able to access the documents 304 after the expiry date of the documents 304 until the expiry date is modified. After the storage of the documents 304, the workspace module 214 may be configured to tag a group of the plurality of groups to a workspace of the workspaces 224. The tagging includes associating one or more users belonging to the group to the workspace. Considering the aforementioned example of the organization whose users are categorized into the HRD Group, the R&D Group, the A/C Group and the Administration Group, each of these groups may be tagged to a specific workspace of the workspaces. In this scenario, a user belonging to the HRD group may be tagged to an HRD workspace. Similarly, another user belonging to the R&D group may be tagged to an R&D workspace, and yet other user belonging to the Administration Group may be tagged to an administrative workspace. The tagging of the plurality of groups, and accordingly the users 302, by the workspace module 214, to the workspaces 224 authorizes the users 302 to access respective workspaces based upon the role and the access right. The table below depicts one embodiment of access rights assigned to different roles:

| Role | Access Rights |
|---|---|
| Super Admin | Workspace Configuration for |
| | specific process |
| | WorkFlow Configuration for |
| | specific process |
| | Field Configuration for specific |
| | process |
| | Assessment Configuration for |
| | specific process |
| | User Management for specific |
| | process |
| | Add/Edit/Delete/View document |
| | Add/Edit/Delete/View work item |
| | of SOP |
| | Search Engine |
| | Configure/Take Assessment |
| | Reports |
| Admin | Assessment Configuration for |
| | specific process |
| | User Management for specific |
| | process |
| | Add/Edit/Delete/View document |
| | Add/Edit/Delete/View work item |
| | of SOP |
| | Search Engine |
| | Configure/Take Assessment |
| | Reports |
| Author | Add/Edit/Delete/View document |
| | Add/Edit/Delete/View work item |
| | of SOP |
| | Search Engine |
| | Configure/Take Assessment |
| | Reports |
| Reviewer | Approver |
| | Search Engine |
| | Configure/Take Assessment |
| Team Member | View Document |
| | View SOP |
| | Search Engine |
| | Take Assessment |

In one embodiment, the workspace module 214 may be further configured to monitor revisions made, by the one or more users, in at least one document belonging to at least one workspace. It must be understood that knowledge evolves and/or enhances over a period of time and hence needs to be enriched or modified. Therefore, the users 302 may be enabled to access the workspaces 224 and revise contents associated with the documents 304 present in the workspaces 224. The workspace module 214 may track revisions made in at least one document and accordingly replace the document with at least one new document. Specifically, the workspace module 214 compares the new document against at least one document available with the same file name and compares the percentage variation of contents in both the documents. In one embodiment, the percentage variation of contents may be calculated using the following formula,

Percentage variation of contents=(Number of changes in a document)/Total number of words in the document)*100

In one embodiment, if the change in the percentage variation of the contents is less than or equal to a predefined percentage value, then such change may be referred to as a minor version change. Alternatively, if the change in the percentage variation of the contents is greater than the predefined percentage value, then such change may be referred to as a major version change. Depending on the change being one of the minor change and the major change, the version number of the one new document is updated. Specifically, the new document is replaced with the one document, both having the same name, with the updated version number which is based upon the variation of the contents in both documents. The version number updated in case of the minor change will be different from the version number updated with the major change. Such version control, the naming convention, and change in predefined percentage value may be configurable by the admin user.

In one embodiment, the workspace module 214 may be further configured to automatically update portions/contents associated with the documents based upon the email(s) or SMS(s) received from the user 302. It is to be noted that, in the existing systems users may have to login to computing systems in order to manually update an existing document. The workspace module 214 may automatically update a specified section of a document based upon the email(s) or SMS(s) received from the users 302. This may be very useful, especially in case of scenarios wherein the users may not be available to access the system and update the specified section in the document. In one embodiment, the email(s) or SMS(s) may be received in a specific format. In one example, the subject line of the email(s) or SMS(s) may comprise information associated with the name of the document and the portion/section of the document to be updated. Further, the body of the email(s) or SMS(s) may comprise content to be updated corresponding to the portion/section of the document. The workspace module 214 may parse the subject line of the email(s) or SMS(s) in order to identify the document, and the portion/section of the document. Further, based upon the identification, the workspace module 214 may append the content from the body of the email(s) or SMS(s) below the portion/section of the document. Such updating of a particular portion of a document takes place in the database and not in the system, thereby eliminating the usage of additional documents in the system. Further, it helps in timely updation of the contents associated with the documents stored in the workspaces without manual intervention of the users.

In one embodiment, the workspace module 214 may be further configured to enable the users 302 to search the documents 304 using one or more search criteria. The one or more search criteria comprises at least one of a keyword, a document name, a document type, a version number, a phrase, a synonym, a field, a tree view, and a tagged keyword. The tree view based search enables the users 302 to search for the document by navigating one or more parent documents, the contents of the one or more parent documents, or one or more child documents intuitively. The tagged keyword enables the users 302 to search for SOP documents stored in the SOP workspace. The SOP documents may be tagged with any keywords. Therefore, the SOP documents may be searched based upon the tagged keywords. FIG. 4B illustrates an example of searching by using tagged keywords. As shown, recipient 320 comprising contents “Percy Fitter” and “Ramesh Nayak” are tagged with their location 322 i.e. “Mumbai”.

It must be understood that in the existing systems, content search is usually carried out by accessing each uploaded document one by one. In contrary to this, the workspace module 214 may be enabled to save contents associated to documents 304 in the internal database (not shown in FIG. 3) of each workspace while uploading the document itself which will fetch the search content quickly as compared to existing systems. For example, in the existing systems, while a user tries to search a content/keyword, the existing systems will access each uploaded document one by one, search the relevant content and display the result. On the contrary, the workspace module 214 may store the contents available in the documents in the internal database of the respective workspace. While searching the contents, the workspace module 214 searches the content available in the respective workspace and hence retrieves the relevant documents quickly. Further, it must be understood that the existing systems while searching the contents fetches the exact word wherever available in the documents stored in the memory of these systems. The output of the search gives the searched content available in any one of the documents. On the contrary, the workspace module 214 of the system 102 not only fetches the exact word but also fetches the content relevant to the synonym words of the searched content available to the documents stored in the workspaces. This helps the users 302 to search and find the relevant contents and synonym words available in the documents.

In one embodiment, the workspace module 214 may be further configured to display the contents of the documents 304 in a language associated with a geographical location of a user. The geographical location may be determined based upon Global Positioning System (GPS) information associated with the user devices 104. By using Global Positioning System (GPS) technology the workspace module 214 enables a user to log into the system 102 depending upon country and the language of users 302. The workspace module 214 may utilize latitude and longitude information in order to determine the country/region.

### Notification Module 216

As illustrated in FIG. 3, the users 302 may be notified by the notification module 216 based upon occurrence of one or more events in the system 102. More particularly, the notification module 216 may notify the user 302 when a document workflow is modified, or at least one document of the documents 304 is stored in at least one workspace of the workspaces 224, or at least one document is replaced with at least one new document. In one embodiment, the users 302 may be notified via an email, or a message, or an audio/video alarm.

### Screen Capture Module 218

As illustrated in FIG. 3, the user devices 104 of the users 302 may be communicatively coupled with the screen capture module 218. The screen capture module 218 may be configured to capture one or more activities performed by the users 302 while accessing the system 102. More particularly, the one or more activities comprising accessing a document, searching a document, attempting an assessment, approving a document, modifying contents in a document, and the like may be captured. One or more activities may be captured using an image capturing means (not shown in figure) by the screen capture module 218. The one or more activities are captured in order to generate an activity file 308 which may be stored in the database 222. The activity file 308 may be an image file or a video file. The screen capture module 218 enables the organization to facilitate better reusability of process/system components by referring to the activity file 308. The activity file 308 facilitates improvement and/or enhancement in the learning process of the users by reusability of existing system landscape available for creating future learning models.

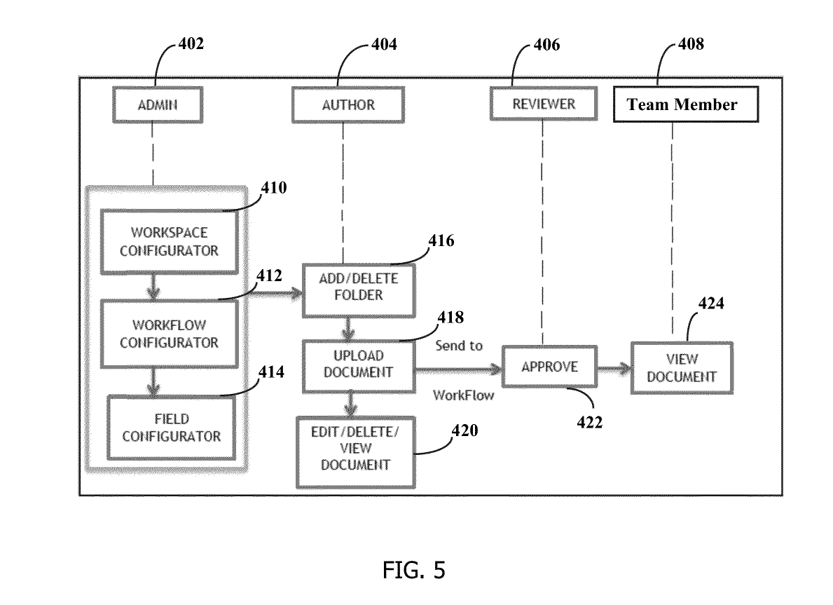

Referring now to FIG. 5, a typical knowledge document (training material) workflow corresponding to a typical knowledge document workspace is shown. As illustrated in FIG. 5, there are four users with four different roles including admin 402, author 404, reviewer 406, and team member 408. The admin 402 may be assigned rights to configure a doc workspace 410, configure a doc workflow 412, and configure a doc field 414. Based upon the configuration of the doc workspace 410, the doc workflow 412, and the doc field 414, the author 404 may be further assigned rights to add or delete folder 416 from the doc workspace. Further, the author 404 may be assigned rights to upload document 418 in the doc workspace. The author 404 may transfer the document to be uploaded to the reviewer 406 in order to approve 422 the document. The author 404 may be assigned rights to edit, delete, or view any document present in the workspace. The reviewer 406 is assigned the rights to approve 422 the document received from the author 404 based upon the configuration of the doc workspace 410. After the approval of the document, the team member 408 may be assigned the rights to view or access 424 the document.

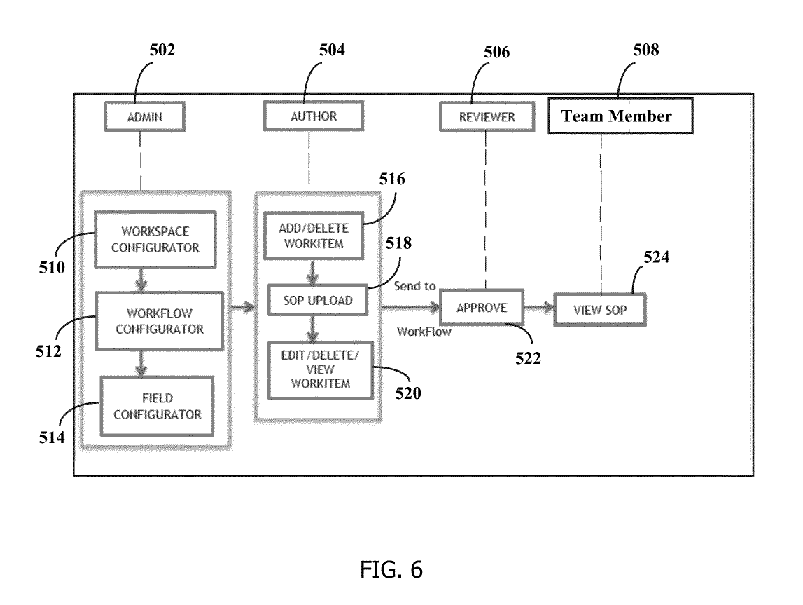

Referring now to FIG. 6, a typical SOP document workflow corresponding to a typical SOP workspace is shown. As illustrated in FIG. 6, there are four users with four different roles including an admin 502, an author 504, a reviewer 506, and a team member 508. The admin 502 may be assigned rights to configure a SOP workspace 510, configure a SOP workflow 512, and configure a SOP field 514. Based upon the configuration of the SOP workspace 510, the SOP workflow 512, and the SOP field 514, the author 404 may be further assigned rights to add or delete a work item 516 from the SOP workspace. Further, the author 504 may be assigned rights to upload a SOP 518 in the SOP workspace. The author 504 may transfer the SOP to be uploaded to the reviewer 506 in order to approve 522 the SOP. The author 504 may be assigned rights to edit, delete, or view any work item present in the SOP workspace. The reviewer 506 is assigned the rights to approve 522 the SOP received from the author 504 based upon the configuration of the SOP workspace 510. After the approval of the SOP, the team member 508 may be assigned the rights to view or access 524 the SOP.

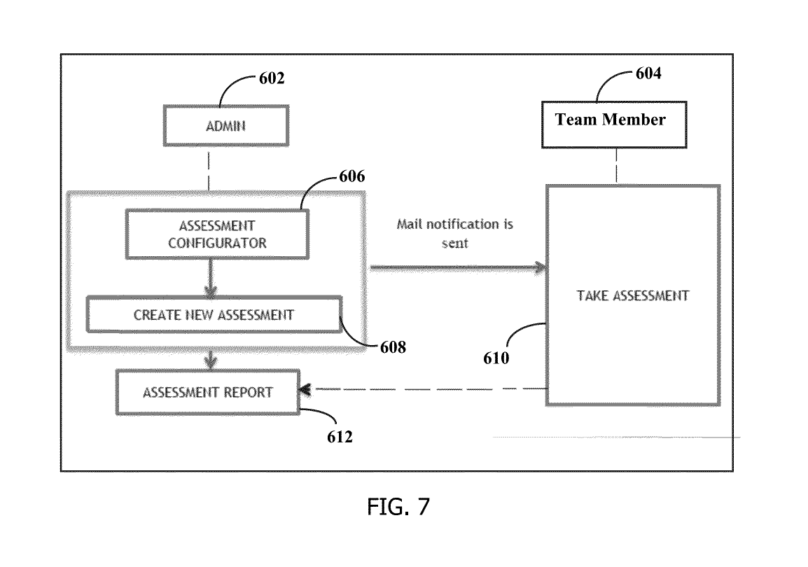

Referring now to FIG. 7, a typical assessment document workflow corresponding to a typical assessment workspace is shown. As illustrated in FIG. 7, there are two users with two different roles including an admin 602 and a team member 604. The admin 602 may be assigned rights to configure 606 an assessment and create the assessment 608. After the creation of the assessment 608, the team member 604 may be notified via an email. The team member 604 may take assessment 610 and submit an assessment report 612. The assessment report 612 also comprises assessment details for the admin 602. The assessment report 612 may comprise information about passing percentage, time duration required for completion of the assessment, number of attempts made in order to pass the assessment, availability of the assessment on the workspace, expiry date of the assessment, and the like.

Exemplary embodiments discussed above may provide certain advantages. Though not required to practice aspects of the disclosure, these advantages may include those provided by the following features.

Some embodiments of the present disclosure enable a centralized knowledge repository for sharing and assessment of knowledge across organization.

Some embodiments of the present disclosure enable configuring a workflow for the approval of the documents to be uploaded on the workspaces, wherein the workflow defined may be customized based upon requirements of the organizations.

Some embodiments of the present disclosure enable configuring a workspace to store documents that are accessed by specific users thereby maintaining data privacy and facilitating data security.

Some embodiments of the present disclosure enable searching for the knowledge assets content using multiple search criteria.

Some embodiments of the present disclosure enable language conversion for knowledge assets in text format as per the requirements of the users.

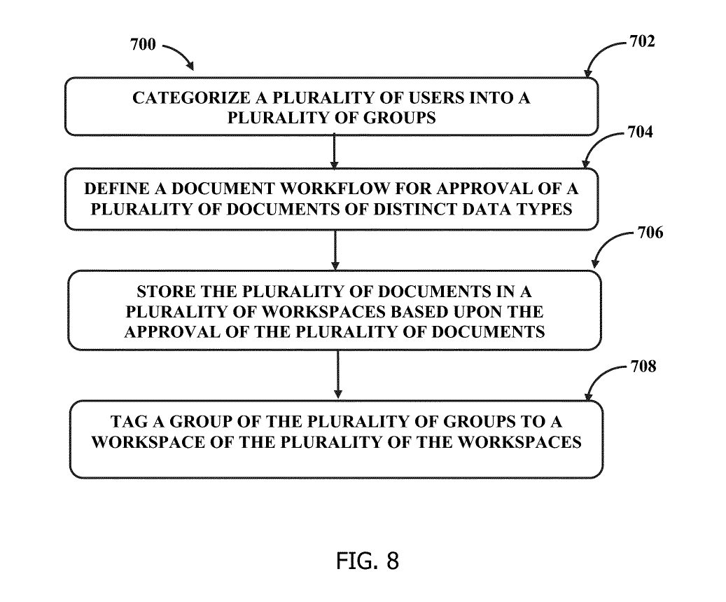

Referring now to FIG. 8, a method 700 for facilitating knowledge management is shown. The method 700 may be described in the general context of computer executable instructions. Generally, computer executable instructions can include routines, programs, objects, components, data structures, procedures, modules, functions, etc., that perform particular functions or implement particular abstract data types. The method 700 may also be practiced in a distributed computing environment where functions are performed by remote processing devices that are linked through a communications network. In a distributed computing environment, computer executable instructions may be located in both local and remote computer storage media, including memory storage devices.

The order in which the method 700 is described is not intended to be construed as a limitation, and any number of the described method blocks can be combined in any order to implement the method 700 or alternate methods. Additionally, individual blocks may be deleted from the method 700 without departing from the spirit and scope of the disclosure described herein. Furthermore, the method can be implemented in any suitable hardware, software, firmware, or combination thereof. However, for ease of explanation, in the embodiments described below, the method 700 may be considered to be implemented in the above described system 102.

At block 702, a plurality of users may be categorized into a plurality of groups. In one implementation, the plurality of users may be categorized by the workflow module 212. Each user may be assigned a role and an access right.

At block 704, a document workflow for approval of a plurality of documents of distinct data types may be defined. In one implementation, the document workflow may be defined by the workflow module 212. The plurality of documents may be approved by one or more users of the plurality of users based upon the role and the access right assigned to the one or more users. In one implementation, the plurality of documents may be created using templates stored in the database 222.

At block 706, the plurality of documents may be stored in a plurality of workspaces. In one implementation, the plurality of documents may be stored in the plurality of workspaces via the workspace module 214.

At block 708, a group of the plurality of groups may be tagged to a workspace of the plurality of workspaces. The tagging is done in a manner such that one or more users belonging to the group are authorized to access the workspace and the documents stored therein. In one implementation, the group may be tagged to the workspace by the workspace module 214.

Although implementations for methods and systems for facilitating knowledge management have been described in language specific to structural features and/or methods, it is to be understood that the appended claims are not necessarily limited to the specific features or methods described. Rather, the specific features and methods are disclosed as examples of implementations for facilitating knowledge management.

What is claimed is:

1. A method for facilitating knowledge management, the method comprising:
providing a computing system connectable to a plurality of user devices, the computing system comprising a processor, an input/output interface, and a memory, the memory having stored therein:
a workflow module configurable by an authorized user to define categories for dividing users into a plurality of groups and to define a role and access rights for the users in each of the plurality of groups; and
a workspace module configurable by the authorized user to store documents in separate workspaces based on the role and access rights defined for the users in the workflow module;
categorizing, based on the workflow module configured by the authorized user, a plurality of users into the plurality of groups, wherein each user is assigned a role and access rights by the workflow module;
defining within the workflow module, as configured by the authorized user, a document workflow hierarchy for approval of a plurality of documents of distinct data types, wherein the approval is based upon the role and the access rights assigned to the plurality of users;
storing within one of the separate workspaces a document of a distinct data type based upon the approval granted by one or more of the plurality of users as set by the workflow module;
tagging by the workspace module a group of users from the plurality of groups to one of the separate workspaces such that one or more users belonging to the group are authorized to access the document stored therein based upon the role and the access rights thereof.

2. The method of claim 1, wherein the role comprises at least one of a super admin, an admin, an author, a reviewer, and a team member.

3. The method of claim 1, wherein the plurality of documents comprise at least one of a knowledge document, a standard operating procedures (SOP) document, an assessment document, and a frequently asked question (FAQ) document.

4. The method of claim 3, wherein the plurality of documents are arranged into at least one of a folder structure and a tree view structure, and wherein the folder structure comprises a document and one or more supporting documents associated to the document, and wherein the tree view structure comprises a parent document and one or more child documents of the parent document.

5. The method of claim 3, wherein the knowledge document is associated with training material, and wherein the assessment document is associated with evaluation of one or more of the users based upon the training material.

6. The method of claim 1, wherein the plurality of documents are created using a plurality of predefined templates, wherein the plurality of predefined templates comprises a plurality of predefined fields, and wherein the plurality of predefined fields comprises at least one of a text box, a drop down, a date, a hyperlink, and an attachment.

7. The method of claim 1, further comprising saving contents associated with the plurality of documents in internal databases of the plurality of workspaces during the storage of the plurality of documents.

8. The method of claim 1, further comprising updating the workflow module by the authorized user performing at least one of,
modifying the role and the access rights,
adding a new role and a new access right, and
deleting the role and the access rights.

9. The method of claim 1, wherein the workspace module monitors revisions made to documents stored therein in the separate workspaces; the method further comprising monitoring, using the workspace module, revisions made, by one or more users, in at least one document belonging to at least one separate workspace, wherein the revisions are indicated as minor variations when the percentage of the revisions are less than or equal to a predefined percentage value, and wherein the revisions are indicated as major variations when the percentage of the revisions are greater than the predefined percentage value, and wherein the at least one document is replaced with at least one new document based upon the revisions made.

10. The method of claim 9, wherein the workspace module stores in metadata associated with each document a version nomenclature thereof; the method further comprising updating the version nomenclature of the at least one new document based upon the revisions being minor variations or major variations such that, the version nomenclature updated in case of the minor variations is distinct as compared to the version nomenclature updated in case of the major variations.

11. The method of claim 10, further comprising notifying the one or more users when,
the document workflow is modified, or
the plurality of documents are stored in the plurality of workspaces, or
the at least one document is replaced with the at least one new document.

12. The method of claim 1, further comprising searching the plurality of documents using one or more search criteria, wherein the one or more search criteria comprises at least one of a keyword, a document name, a document type, a version number, a phrase, a synonym, a field, a tree view, and a tagged keyword.

13. The method of claim 12, further comprising performing a search on the contents saved in the internal databases of the plurality of workspaces, and wherein the search performed enables an identification of a content relevant to one of the keyword, the synonym, and the phrase, and wherein the content enables retrieval of at least one document associated with the content.

14. The method of claim 1, further comprising displaying contents of the plurality of documents in a language associated with a geographical location of the plurality of users, wherein the geographical location is determined based upon GPS information associated with one or more display devices of the plurality of users.

15. The method of claim 1, further comprising capturing a plurality of activities associated to the plurality of users using an image capturing means in order to generate an image/video file storing the plurality of activities.

16. The method of claim 1, further comprising automatically updating a portion or a section of a document based on an email or a Short Message Service (SMS) received from a user, wherein the email or the SMS comprises content to be updated corresponding to the portion or the section of the document, and wherein the email or the SMS further comprises name of the document and the portion or the section of the document to be updated.

17. A system for facilitating knowledge management, the system comprising:
a processor;
a memory coupled to the processor, wherein the processor is capable for executing a plurality of modules stored in the memory, and wherein the plurality of modules comprising:
a workflow module configured to,
categorize a plurality of users into a plurality of groups, wherein each user is assigned a role and an access right, and
define a document workflow for approval of a plurality of documents of distinct data types, wherein the plurality of documents are approved by one or more users of the plurality of users based upon the role and the access right assigned to the one or more users; and
a workspace module configured to,
store the plurality of documents in a plurality of workspaces based upon the approval of the plurality of documents, and
tag a group of the plurality of groups to a workspace of the plurality of the workspaces such that one or more users belonging to the group are authorized to access the workspace and the documents stored therein, wherein the one or more users are authorized to access the workspace based upon the role and the access right.

18. A computer program product having embodied thereon a computer program for facilitating knowledge management, the computer program product comprising a set of instructions, the instructions comprising instructions for:
categorizing a plurality of users into a plurality of groups, wherein each user is assigned a role and an access right;
defining a document workflow for approval of a plurality of documents of distinct data types, wherein the plurality of documents are approved by one or more users of the plurality of users based upon the role and the access right assigned to the one or more users;
storing the plurality of documents in a plurality of workspaces based upon the approval of the plurality of documents; and
tagging a group of the plurality of groups to a workspace of the plurality of the workspaces such that one or more users belonging to the group are authorized to access the workspace and the documents stored therein, wherein the one or more users are authorized to access the workspace based upon the role and the access right.
